(19) United States
(12) Patent Application Publication
(10) Pub. No.: US 2014/0266583 A1
(43) Pub. Date: Sep. 18, 2014

(54) Capturing Code Sequences

(71) Applicant: KeylessRide, Georgetown, TX (US)

(72) Inventor: Emmanuel Enrique Lopez, Georgetown, TX (US)

(73) Assignee: KeylessRide, Georgetown, TX (US)

(21) Appl. No.: 14/211,722

(22) Filed: Mar. 14, 2014

Related U.S. Application Data
(60) Provisional application No. 61/790,245, filed on Mar. 15, 2013.

(51) Int. Cl. G07C 9/00

(52) U.S. Cl. CPC G07C 9/00015
USPC 340/5.26

(57) ABSTRACT

A subset of codes is efficiently captured from a remote generator and used in a remote access device. The subset of codes contains more codes for common functions than for uncommon functions and enables operation of special functions.

### CROSS-REFERENCE TO RELATED APPLICATIONS

This application claims priority to U.S. application Ser. No. 61/790,245, filed on Mar. 15, 2013.

### TECHNICAL FIELD

This invention relates to remote keyless vehicle access systems, and more particularly to access codes of the remote keyless vehicle access systems.

### BACKGROUND

Wireless signal transmitter-receiver systems are employed in a variety of security systems and remote activation systems. Remote access devices are generally used in the automotive industry to activate and deactivate vehicle access systems. Remote access devices can also perform other tasks including remote starting, locking and unlocking doors, unlatching trunk decks or tail gates, opening windows or doors and operating convertible top mechanisms.

Remote access devices may use a code generator capable of generating a very large number of base codes to operate with a vehicle access system. For example, the very large number can be in the thousands, millions, billions, or higher. Furthermore, each generated base code can be combined with a function code, effectively multiplying the already large number of base codes.

3^{rd} parties might want to build replacement remote access devices, but they might not know the code generator's algorithm or seed. Many vehicle access systems protect against direct copying of previously used wireless signals by enforcing ranges or windows of valid access codes and rejecting access codes outside of the windows.

### SUMMARY

One aspect of the invention features capturing a subset of output codes from a rolling code sequence device. This is done by actuating a first function of the device to use a first base value of the rolling code sequence to generate a first output code. After the actuation of the first function but before actuating any other function, the first function is actuated again to generate a second output code. Then, other functions may be actuated to generate more output codes. The output codes are stored into a memory as a new sequence of access codes in the order of output, namely the first output code, the second output code, and then the third output code.

In some implementations, the rolling code sequence device is a remote access device. When a function of the remote access device is actuated, it uses the next sequential value generated by a rolling code generator to generate an output code.

In one implementation, the first and second functions may be lock or unlock functions. Other functions may include a trunk function, panic function, window function, sync function, remote start function, and others.

In some implementations, capturing the subset of output codes involves actuating a special sequence of functions of the device to generate a special sequence of output codes. The special sequence may operate a special event, such as a code sync event. The special event may be a different event such as panic, remote start, or others. The special sequence of output codes is stored as a part of the new sequence of access codes.

In some implementations, the device is a remote access transmitter configured to be paired with a receiver. The paired receiver is configured to use a rolling code generator to verify codes received from the transmitter. The receiver may resynchronize the rolling code generator upon receiving a special sync sequence of output codes.

In another implementation, sets of functions are repeatedly actuated. The output codes are appended to the subset of output codes in the order generated by the device. Actuating each set of functions can include actuating the first function, followed by actuating the first function again, followed by actuating other functions at least once. Sometimes, actuating each set of functions includes actuating another function followed by actuating the another function again.

Another aspect of the invention features a remote transmitter for sending codes to a receiver. The remote transmitter can have a memory storing a subset of output codes, the subset of output codes comprising, in sequential order, a first code, a second code, and then a third code. It may have an input system configured to receive a selected function of among a plurality of functions operable on the receiver. It may have an antenna configured for sending codes to the receiver. The first code operates a first function, and the second code operates the first function, and the third code operates a second function.

In different implementations, the first function can be a lock function, an unlock function, or some other function.

In another implementation, the subset of codes further comprises a special sequence of codes. A receiver paired to the transmitter will resynchronize a rolling code generator upon the receiver receiving the special sequence of codes.

In some implementations, each code in the subset of output codes operates one of the plurality of functions of the receiver. The subset of codes comprises a sequence of groups of codes. Each group of codes comprises for each one function of the plurality of functions, at least one code configured to operate that one function of the receiver. Also each group of codes comprises two consecutive codes configured to operate the first function.

In some implementations, the transmitter is configured to, upon receiving an input to operate a specific function of the plurality of functions, transmit a specific code from the subset of output codes configured to operate the specific function. The transmitter is configured to, upon receiving a next input to operate a next function the plurality of functions and before receiving any other input, transmit the earliest code in the sequence after the specific code that operates the next function of the plurality of functions.

In some implementations, each group of codes further comprises a special sequence of codes that, when received by the receiver, cause the receiver to resynchronize a rolling code generator of the receiver, the rolling code generator used to verify codes received from the transmitter.

In some implementations, the first code matches a first output code of a rolling code sequence device generated by actuating a first function of the device. The second code matches a second output code of the device generated by again actuating, after the actuation of the first function but before actuating any other function, the first function of the device. The third code matches a third output code of the device generated by actuating, after the again actuation, a second function of the device.

In some implementations, the device is configured to, for any actuated function of a plurality of functions, use a next sequential value from a rolling code generator to generate an output code.

Another aspect of the invention features a method, performed by a transmitter, of transmitting codes to a receiver. Upon receiving an input to operate a specific function of a plurality of functions operable by the receiver, the transmitter transmits a specific code from a sequential subset of codes configured to operate the specific function. Upon receiving a next input to operate a next function of the plurality of functions and before receiving any other input, the transmitter transmits the earliest code in the sequential subset of codes after the specific code that operates the next function of the plurality of functions. The receiver is configured to use a rolling code generator to verify codes received from the transmitter. The sequential subset of codes comprises, in sequential order, a first code, a second code, and then a third code. The first code and second code operate a first function of the plurality of functions. The third code operates a second function of the plurality of functions, the second function different from the first function.

In different, the first function is a lock function, unlock function, or other function

In some implementations, the sequential subset of codes comprises a sequence of groups of codes. Each group has, for each one function of the plurality of functions, at least one code configured to operate that one function. The group also has two consecutive codes configured to operate the first function.

In some implementations, upon receiving a special sequence of inputs to operate a special sequence of functions, the transmitter transmits a special sequence of codes to cause the rolling code generator to synchronize.

In some implementations, each group of codes comprises special consecutive codes that, when sent to the receiver, will cause the rolling code generator to synchronize.

In some implementations, the first code matches a first output code of a rolling code sequence device generated by actuating a first function of the device. The second code matches a second output code of the device generated by again actuating, after the actuation of the first function of the device but before actuating any other function of the device, the first function of the device. The third code matches a third output code of the device generated by actuating, after the again actuation, a second function of the device.

One aspect of the invention features capturing a subset of output codes for operating a plurality of functions. A sequence of output codes is generated by repeatedly performing sets of sequential function actuations on a rolling code sequence device. The subset of output codes comprising the sequence of output codes is stored into a memory. In each set of sequential function actuations, a common function of the set is actuated for a plurality of times, an uncommon function of the set is actuated for a number of times that is less than the plurality, and each function of the set is actuated at least once.

In some implementations, each set of sequential function actuation is a same set of sequential function actuations of a same number of function actuations. In other implementations, the sets of sequential function actuations may be different in order, number or both.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an example remote access device containing codes from an original generator.

FIG. 2 is an example showing output codes when functions are actuated.

FIGS. 3A-3C show example subsets of codes and corresponding functions.

FIGS. 4A-4B show example function inputs and code outputs for subsets of codes.

FIG. 5 shows an example method for capturing a subset of codes.

FIG. 6 shows another example method for capturing a subset of codes.

FIG. 7 shows another example method for capturing a subset of codes.

FIG. 8 shows another example method for capturing a subset of codes.

Like reference symbols in the various drawings indicate like elements.

### DETAILED DESCRIPTION

FIG. 1 is a block diagram that shows an example remote access device 110 containing codes from an original generator 150. The original generator can be, for example, a key fob originally provided by a manufacturer for use with a vehicle type. The original code generator may contain a rolling code generator. The remote access device can be a replacement key fob that can be made without a rolling code generator. The original generator 150 has inputs 151[a-c] for lock 151a, unlock 151b, and trunk 151c functions. A rolling code generator 153 generates an output code based on the actuated function. An index counter 157 can change, such as by incrementing, every time an output code is generated.

When a first function is actuated, the output generator will generate a first output code based on the actuated first function and a rolling code for the given index. In this example, the index is also incremented by one. In other examples, the index may change in a linear, non-linear manner, a random or pseudo-random manner, or other non-incremental manner. In the following examples, the output code is the rolling code appended to the function code. In other examples, the output code is a logical function or other combination of the rolling code and the function code. The original generator 150 uses an antenna 155 for wireless communication of the output code. Upon actuating a second function, the output generator will generate a second output code based on the actuated second function and a rolling code for the given index. The original generator can use the next incremental code for any actuated function.

The replacement remote access device 110 has inputs 111[a-c] for the same functions lock, 111a, unlock 111b, and trunk 111c. Control logic such as a microcontroller unit 113 registers a user's input and looks up data in memory 115. The memory may contain a series of output codes 119 and a series of functions 121 that correspond to certain output codes in the series 119. The output codes are a subset of the output codes that can be output by the code generator.

The replacement remote access device 110, upon receiving a first input of the lock 111a function, finds the first output code that corresponds to the lock function and wirelessly sends the first output code via antenna 117. Upon subsequently receiving a second unlock function input 111b, the microcontroller unit searches through the memory for the next code after the first output code that corresponds to the unlock input. This may not necessarily be the immediately subsequent output code, and in some cases several output codes can be skipped. The replacement remote access device then sends the properly corresponding output code via the antenna.

FIG. 2 is an example table 200 showing output codes 213 of an original generator upon receiving actuated input functions 211. The first column of the table lists the incrementing index counter. The second column of the table lists the base code value that will be used with each index. The remaining columns show what the output code will be when a certain function A, B, C, or D is pressed. These can represent any of lock, unlock, trunk, panic, sync, window, remote start, honk, or other functions of a vehicle access system.

For each function that is input, the remote access device uses a base code value corresponding to a current index to generate the outputs shown in the columns of table 210 for the input function, and the index will increment. In this example, the table has 2̂32 values (totaling 4,294,967,296), after which the index will roll back to 1.

When the original generator starts at an index of 1 and receives the first input of function A, it will use Base Code 1 to generate the output Code A1 indicated by 220. The index then increments to 2. When the next input of function A is received, it will then use the corresponding Base Code 2 to generate the output Code A2 as indicated by 221. The index then increments to 3. When the next input B is received, the Base Code 3 corresponding to index 3 is used to generate the output Code B3 as indicated by 222. The index then increments to 4. When the next input A is received, the Base Code 4 corresponding to index 4 is used to generate the output Code A4 as indicated by 223. The index then increments to 5. When the next input A is received, the Base Code 5 corresponding to index 5 is used to generate the output Code A5 as indicated by 224.

FIGS. 3A-3B show example tables 300, 330, and 360 illustrating subsets of codes and corresponding functions. A replacement remote access device 110 can store one of these tables to look up codes for operating with a vehicle access system without the use of the original rolling code generator. The table 300 of FIG. 3A shows a first subset of 524,288 total codes (indicated by 390) that each operates only one of the four functions. Table 300 contains far fewer codes than the 4,294,967,296 base codes that can be used to generate output codes for each of four functions. FIGS. 3b and 3c show other differently selected subsets of 524,288 codes that operate a different order of functions.

A 3^{rd} party producer of replacement remote access devices can generate the code subset in table 300 by sequentially and repeatedly operating function A, then B, then C, and then D on an original generator and recording the output. Alternatively, the 3^{rd} party producer can generate the code subset in table 330 by sequentially and repeatedly operating function A, then A, then B, then C, and then D on an original generator and recording the output. Alternatively, a 3^{rd} party producer can generate the code subset in table 360 by sequentially and repeatedly operating function A, then A, then B, then D, then B, then C on an original generator and recording the output until reaching the last code A524288 (as indicated by 390c). The tables stored in memory can be designed to roll over and start the subset from the beginning when the sequence is exhausted.

In some situations, replacement key containing tables 330 or 360 in the memory will use the codes more efficiently than a replacement key containing table 300. This may happen if a user operates function A or B more often than other functions. For example, function A might operate a door unlock function, while function D operates the trunk open function. A vehicle owner may need to unlock the car almost every time it is used, such as for a daily commute to and from work, but the vehicle owner may only operate the trunk once a week during a grocery shopping trip.

Table 360 includes a special order of functions “B, D, B.” Such a special order of functions may operate a special function on a vehicle access system. Examples of special functions include sync, remote start, and other functions. Some vehicle access systems will only operate a special function when consecutively ordered codes operate a certain sequence of functions, in this case “B, D, B.” In these vehicle systems, Code B3, Code D4, Code B5 will operate the special function because the consecutive codes operate the required sequence of functions, but the non-consecutive sequence of Code B5, Code D10, Code B11 will not operate the special function.

In other examples, a second special order of functions may operate a different special function, and this second order of functions may be included in the new subset of codes. For example, a sync sequence may require that a single button be actuated twice in a row. The sync sequence may simultaneously require the consecutive codes from the sequence of access codes. Some vehicle access systems will reject any access code outside a range or window of the next expected access codes in a sequence. However, they sync sequence will cause the vehicle access system to synchronize the window so that the vehicle access system will allow the next access code sent by the remote access device. This may result in overlapping functionality, for instance when function A is a commonly used function, such as unlock doors, and pressing function A twice operates a special feature, such as rolling down windows. In such a scenario, the sequence “A, A, B, C, D” simultaneously allows for rolling down windows and allows for efficient capturing of code. In contrast, the sequence “A, B, C, D” of table 300 does not allow a user to press the same function to generate a sync sequence because no consecutive codes operate the same function.

FIGS. 4A-4B show example function inputs and code outputs for a subset of codes. In FIG. 4A, the table 300 displays a first ordered subset of code. A vehicle access system receiving one of the codes will perform the function for that code as indicated by the table. When an input 411 for a specific function is received by a remote access device having the codes of table 300, the remote access device will output the next code corresponding to that specific function.

For example, the remote access device implementing table 300 receives the ordered input sequence 411 of functions “A, A, B, A, A.” In processing the ordered input sequence of functions, the remote access device looks up the first code 420 that corresponds to the first function A input. The remote access device will output 420 Code A1 from the table. Then, upon receiving the second function A input, the remote access device will output the next code 421 that operates function A, which is Code A5. A controller, processor, or logic of the remote access device will skip Code B2, Code C3, and Code D4 because they do not operate functions A. Upon receiving the B function input, the remote access device outputs the next code 422 that operates function B, which is Code B6. Upon receiving the function A input, the remote access device outputs the next code 423 that operates function A, which is Code A9. The remote access device skips Code C7 and Code C8 because they did not operate the requested function. Upon receiving the final function A from the ordered input sequence of functions, the remote access device outputs 424 Code A13, again skipping over output codes that operate different functions.

Operating the sequence of five inputs “A, A, B, A, A,” required skipping 8 codes that did not operate a requested function. This input sequence iterates through a total of 13 codes from the table.

FIG. 4B shows a table 330 containing a subset of codes that operate a different sequence of functions. The subset of code, if used in order without skipping any codes, repeatedly operates functions “A, A, B, C, D.” This may result in a more efficient operation if function A is used more frequently than the other functions.

In processing the ordered input sequence of functions, the remote access device looks up the first code 460 that corresponds to the first function A input. The remote access device will output 452 Code A1 from the table. Then, upon receiving the second function A input, the remote access device will output the next code 461 that operates function A, which is Code A2. Upon receiving the function B input, the remote access device outputs the next code 462 that operates function B, which is Code B3. Upon receiving the next function A input, the remote access device outputs the next code 463 that operates function A, which is Code A6. A controller, processor, or logic of the remote access device will skip Code C4 and Code D5 because they did do operate the correct function. Upon receiving the final function A from the ordered input sequence of functions, the remote access device outputs 464 Code A7, again skipping over output codes that operate different functions.

Operating the sequence of five inputs “A, A, B, A, A,” requires skipping two codes that did not operate the requested function. Therefore, this input sequence iterates through a total of 7 codes from the table.

A first replacement remote access device using the sequence of codes in table 330 can operate more efficiently than a second replacement remote access device using the sequence of codes in table 300. In the examples where function A is commonly used, the first replacement remote access device uses fewer codes from the sequence. This reduces the likelihood of iterating through a sequence of access codes to a point outside of the window of codes allowed by a vehicle access system. It also allows for fewer total codes to be stored into a memory.

FIG. 5 is a flow diagram of an example method 500 for capturing a subset of codes where function A is a commonly used function. Actuating 501 a first function such as function A on an original generator generates a first output code for capturing 509 as the first code of a new subset of code. Actuating 503 function A for a second time generates a second output code for capturing 509 as the second code in the new subset of code. Actuating 505 a second function such as function B generates a third output code for capturing 509 as the third code in the new subset of code. Actuating remaining 507 functions generates more output codes, which are then captured 509 into the new sequence as well. The captured codes are stored 509 into a memory 115. The process is repeated 511 for a sufficient number of codes. Generally, the order of codes in the new sequence is the same as the order of codes output from the original generator.

Capturing an output code comprises reading the output code and recording the output code. In some cases, the output code is stored into a memory. Reading the output code can be done by probing the circuit of the original generator, by analyzing the wireless output from the antenna of the original generator, by digitally reading parts of the circuit, or other electric analysis techniques. In some implementations, storing the output codes can occur as part of capturing the codes.

FIG. 6 shows another example method 600 for capturing a subset of codes where function A is a commonly used function. Actuating 601 a first function such as function A on an original generator generates a first output code. Actuating 603 function A for a second time generates a second output code. Actuating 605 a special sequence of output codes such as “B, D, B” generates additional output codes. Actuating 607 remaining functions generates more output codes. The output codes are captured in the order generated and stored 609 as a new subset into a memory of a remote access device. Repeating 611 the process generates more output codes for a desired number of output codes.

FIG. 7 shows another example method for capturing a subset of codes containing the sequence “D, A, A, B, C,” where the “A, B” is a special sequence 720, function A is a commonly used function, and functions C and D are remaining functions 730. Here, function A serves two purposes as the common function and as part of the special sequence. Actuating 701 function D generates the first output code for capturing into the new subset. Actuating 703, 705 function A twice 710 generates the second and third output codes for capturing into the new subset. Actuating 707 function B next ensures that the remote access device can operate the special functionality of a vehicle remote access system. Actuating function C generates a fifth output code for capturing into the new subset.

FIG. 8 shows another example method 800 for capturing a subset of codes. In this example, Function A is more commonly used than function B. The sequence “A, A” causes a synchronization event with a paired access system. Functions C and D are the remaining functions. First, the method 500 as process 801 to actuate sequence “A, A, B, C, D” (as indicated by 821, 823, 825). The resulting output codes for “A, A, B, C, D” are stored as the new subset of code. Step 805 shows a single “repeat” process 511 where “A, A, B, C, D” are actuated again and the output codes are appended to the new subset of code.

In step 809, a third set of functions is actuated in a different order: A, A, C, C, B, B, D, A so that the common function A is actuated a total of 3 times. First, function A is actuated 841 twice. Remaining function C is actuated 843 at least once. Uncommon function B is actuated 845 at least once but less than the three times that function A is actuated. Remaining function D is actuated 847 at least once. Function A is actuated 849 the third time. The output codes are appended 811 to the subset of codes in the order output by the original generator. So far, the subset of this example includes A, A, B, C, D, A, A, B, C, D, A, A, C, C, B, B, D, A.

In step 813, more sets of functions are actuated. The sets can be of varying lengths. Each set can have at least one common function that is actuated more than an uncommon function. Each set can have a special order of functions necessary to perform a special function on a vehicle remote access system.

A number of embodiments of the invention have been described. Nevertheless, it will be understood that various modifications may be made without departing from the spirit and scope of the invention. For example, the code generator 153 can be a different type of code generator. The index counter may or may not be used with any of the tables. Functions can be encoded with base codes in different ways. The embodiments use lock, unlock, and trunk as examples of functions, but are additional functions can be used in a similar way. Different functions can be more common than others. The codes can be captured in varying sequences. Accordingly, other embodiments are within the scope of the following claims.

What is claimed is:

1. A method for capturing a subset of output codes from a rolling code sequence device comprising:
actuating a first function of the device to generate a first output code;
after the actuation of the first function but before actuating any other function, again actuating the first function of the device to generate a second output code;
after the actuation of the first function again, actuating a second function different from the first function of the device to generate a third output code; and
storing into a memory the subset of output codes comprising, in sequential order, the first output code, the second output code, and then the third output code.

2. The method of claim 1, wherein the device is remote access device configured to, for any actuated function of a plurality of functions, use a next sequential value from a rolling code generator to generate an output code.

3. The method of claim 1, wherein the first function is one of a lock function and an unlock function.

4. The method of claim 1, further comprising:
actuating a special sequence of functions of the device to generate a special sequence of output codes; and
storing the special sequence of output codes as a part of the new sequence,
wherein the device is a remote access device configured to be paired with a receiver, the receiver configured to use a rolling code generator to verify codes received from the transmitter; and
wherein the receiver is configured to resynchronize the rolling code generator upon receiving the special sequence of output codes.

5. The method of claim 1, further comprising:
repeatedly actuating sets of functions; and
appending output codes to the subset of output codes in the order generated by the device,
wherein actuating each set of functions comprises:
actuating the first function followed by actuating the first function again; and
actuating each function of the plurality of functions at least once.

6. The method of claim 5, wherein each set of functions further comprises another function followed by the another function again.

7. A remote transmitter for sending codes to a receiver comprising:
a memory storing a subset of output codes, the subset of output codes comprising, in sequential order, a first code, a second code, and then a third code;
an input system configured to receive a selected function of among a plurality of functions operable on the receiver; and
an antenna configured for sending codes to the receiver;
wherein the first code operates a first function of the plurality of functions;
wherein the second code operates the first function of the plurality of functions; and
wherein the third code operates a second function of the plurality of functions.

8. The transmitter of claim 7, wherein the first function is one of a lock function and an unlock function.

9. The transmitter of claim 7, wherein the subset of codes further comprises a special sequence of codes,
wherein a receiver paired to the transmitter will resynchronize a rolling code generator of the receiver upon the receiver receiving the special sequence of codes.

10. The transmitter of claim 7,
wherein each code in the subset of output codes operates one of the plurality of functions of the receiver;
wherein the subset of codes comprises a sequence of groups of codes; and
wherein each group of codes comprises:
for each one function of the plurality of functions, at least one code configured to operate that one function of the receiver; and
two consecutive codes configured to operate the first function.

11. The transmitter of claim 10,
wherein the transmitter is configured to, upon receiving an input to operate a specific function of the plurality of functions, transmit a specific code from the subset of output codes configured to operate the specific function; and
wherein the transmitter is configured to, upon receiving a next input to operate a next function the plurality of functions and before receiving any other input, transmit the earliest code in the sequence after the specific code that operates the next function of the plurality of functions.

12. The transmitter of claim 10, wherein each group of codes further comprises a special sequence of codes that, when received by the receiver, cause the receiver to resynchronize a rolling code generator of the receiver, the rolling code generator used to verify codes received from the transmitter.

13. The transmitter of claim 7,
wherein the first code matches a first output code of a rolling code sequence device generated by actuating a first function of the device;
wherein the second code matches a second output code of the device generated by again actuating, after the actuation of the first function but before actuating any other function, the first function of the device; and
wherein the third code matches a third output code of the device generated by actuating, after the again actuation, a second function of the device.

14. The transmitter of claim 13, wherein the device is configured to, for any actuated function of a plurality of functions, use a next sequential value from a rolling code generator to generate an output code.

15. A method, performed by a transmitter, of transmitting codes to a receiver, the method comprising:
upon receiving an input to operate a specific function of a plurality of functions operable by the receiver, transmit a specific code from a sequential subset of codes configured to operate the specific function; and
upon receiving a next input to operate a next function of the plurality of functions and before receiving any other input, transmit the earliest code in the sequential subset of codes after the specific code that operates the next function of the plurality of functions,
wherein the receiver is configured to use a rolling code generator to verify codes received from the transmitter;
wherein the sequential subset of codes comprises, in sequential order, a first code, a second code, and then a third code;
wherein the first code operates a first function of the plurality of functions,
wherein the second code operates the first function of the plurality of functions, and
wherein the third code operates a second function of the plurality of functions, the second function different from the first function.

16. The method of claim 15, wherein the first function is one of a lock function and an unlock function.

17. The method of claim 15, wherein the subset sequential subset of codes comprises a sequence of groups of codes, and each group comprises:
for each one function of the plurality of functions, at least one code configured to operate that one function; and
two consecutive codes configured to operate the first function.

18. The method of claim 17 further comprising:
upon receiving a special sequence of inputs to operate a special sequence of functions, transmitting a special sequence of codes to cause the rolling code generator to synchronize.

19. The method of claim 18, wherein each group of codes comprises special consecutive codes that, when sent to the receiver, will cause the rolling code generator to synchronize.

20. The transmitter of claim 15,
wherein the first code matches a first output code of a rolling code sequence device generated by actuating a first function of the device;
wherein the second code matches a second output code of the device generated by again actuating, after the actuation of the first function of the device but before actuating any other function of the device, the first function of the device; and
wherein the third code matches a third output code of the device generated by actuating, after the again actuation, a second function of the device.

21. A method for capturing a subset of output codes for operating a plurality of functions from a rolling code sequence device comprising:
generating a sequence of output codes by repeatedly performing sets of sequential function actuations on the rolling code sequence device; and
storing into a memory the subset of output codes comprising the sequence of output codes;
wherein each set of sequential function actuations comprises:
actuating, for a plurality of times, a common function; and
actuating, for a number of times that is less than the plurality, an uncommon function; and
actuating each function of a plurality of functions at least once.

22. The method of claim 21, wherein each set of sequential function actuation is a same set of sequential function actuations of a same number of function actuations.
